(19) United States
(12) Patent Application Publication
(10) Pub. No.: US 2003/0158658 A1
(43) Pub. Date: Aug. 21, 2003

(54) Navigation method with dynamic destination selection and navigation device

(76) Inventors: Georg Hoever, Muenchen (DE); Oliver Maeckel, Muenchen (DE); Martin Rothfelder, Muenchen (DE)

Correspondence Address: BAKER BOTTS, LLP, 910 LOUISIANA, HOUSTON, TX, 77002-4995, US

(21) Appl. No.: 10/221,430

(22) PCT Filed: Jan. 9, 2002
(86) PCT No.: PCT/DE02/00035

(30) Foreign Application Priority Data
Jan. 11, 2001 (DE) 101 00 956.9

(51) Int. Cl. G01C 21/30

(52) U.S. Cl. 701/209

(57) ABSTRACT

A navigation method involves a processor selecting at least one destination from a stipulated destination category containing a plurality of destinations (P₁; P₂; P₃; P₄) and calculating a route to the destination. In the event of a change in the location (V₁; V₂), the processor checks whether a new destination (P₁; P₂; P₃; P₄) from the stipulated destination category is closer to the changed location. If the new destination is closer to the changed location, a route is calculated from the changed location to the new destination and is output to a user. In this way, dynamic, automatically changeable destination selection is performed which takes into account the actual course of a journey route.

The invention relates to a navigation method with dynamic destination selection, and to a navigation appliance permitting dynamic destination selection.

Pages 18 and 19 of the periodical auto connect 2/2000, appearing in Vereinigte Motor-Verlage, Stuttgart, disclose a navigation appliance with specific destination input for special destinations (Points Of Interest, POI). A special destination can be set by inputting a town and selecting the menu item “surrounding destinations”. The surrounding destinations show special destinations associated with the selected town. From these special destinations, the user can select one. The navigation appliance then determines a route to the special destination. The navigation appliance also has a function which is used to combine individual destinations to produce complete routes. If the user of the navigation appliance changes his route, for example on account of a traffic jam, the navigation appliance nevertheless continues guidance to the previous special destination, even though the deviation from the originally planned route means that another special destination in the same category could be reached better from the new location.

It is an aim of the invention to provide a navigation method and a navigation appliance which permit dynamic destination selection where a destination can be selected automatically.

This aim is achieved with a navigation method and a navigation appliance as defined in the independent patent claims. Advantageous developments of the invention are specified in the subclaims.

On the basis of the invention, it is sufficient for a user to stipulate a destination category or destination group. The specific destination is then determined automatically by the processor, and not by the user. The route planning and routing thus involve taking into account a plurality of destinations and selecting the suitable destination automatically. Automatic destination stipulation is particularly useful if it is necessary to head for a destination from one of the destination categories or destination groups comprising police stations, hospitals, filling stations, multistory car parks, railway stations, post offices or the like. The user is taken to a useful destination from the chosen destination category even if he has not entered a town or district as a destination.

Preferably, the destination is automatically changed as required on the basis of the course of a journey. If the user cannot or does not wish to follow the originally calculated route to the destination, the destination is therefore reselected from the stipulated destination category if another destination in the same destination category is more favorably placed for the new route.

In one preferred embodiment, a route is calculated which usefully runs via all the destinations in a stipulated destination category. It is therefore possible to visit attractions along a journey route to a destination, for example. In addition, information about the respective attraction headed for can be output. These attractions can be intermediate destinations on a route to a finishing point chosen by the user or by the processor.

Other advantages, features and opportunities for application of the invention can be found in the description below of an exemplary embodiment in connection with the drawings, in which:

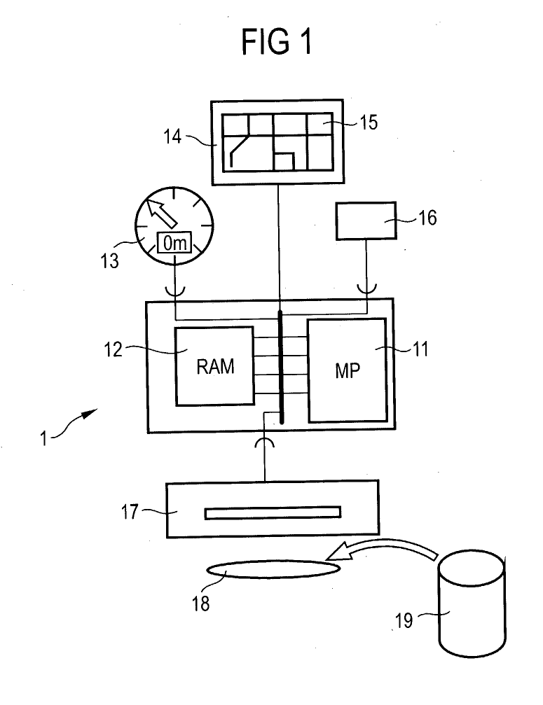

FIG. 1 shows a navigation appliance, and

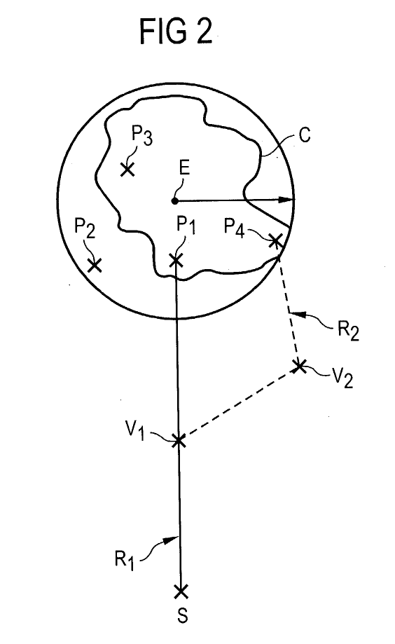

FIG. 2 shows a route to destinations determined by the navigation appliance.

FIG. 1 shows a navigation appliance 1, built into a car, which has a processor 11 (microprocessor) and a memory 12. This memory 12 is a non volatile, overwriteable main memory. The processor 11 has further components connected to it via a bus system. These include position sensors 13 with a distance sensor, with a direction sensor and with a GPS satellite receiver, a display device 14 allowing digital road maps 15 and calculated routes to be displayed, a mobile telephone unit 16 which can be used to receive traffic announcements and to use them for route calculation, and a drive 17 for a storage medium 18, namely a DVD (Digital Versatile Disc).

The storage medium 18 stores at least one database 19 containing a network of road segments on the digital road map 15. In addition, the database 19 stores destination categories in which respective special destinations of a generic type are combined to form destination groups. The destination categories or destination groups listed are police stations, hospitals, multistory car parks, filling stations, post offices and railway stations. In addition, the individual special destinations in a destination category have opening times for filling stations, post offices or multistory car parks, timetables for railway stations or stopping places and tariffs for the use of multistory car parks, car parks and roads indicated for them, if available. This additional information is used for route planning, so that, by way of example, instead of the next special destination, which is closed, the processor 11 chooses one which is further away, but which is open. Similarly, the stopping place of a transport means whose departure times are favorable for the anticipated arrival of the user might be selected. In addition, the processor can take the available tariff information regarding road tolls or parking fees as a basis for calculating the least expensive route taking into account journey time, journey costs and ancillary costs.

Besides this, the user can himself create destination categories in the main memory 12 and can assign destinations in the database 19 to these destination categories.

FIG. 2 shows a starting point S from which a user wishes to set off and a finishing point E.

The specific finishing point E of the journey can be determined either by the user or by the navigation appliance. In the latter case, the user enters “hotel” in a particular price or comfort class and a destination as a destination category, for example. The navigation appliance's processor then uses the details held in its database to ascertain the least expensive destination taking into account the journey costs and the price information stored in the database for the hotel rooms [lacuna] the best hotel. If it is possible to retrieve information about the occupancy of this selected hotel on the hotel's home page on the Internet, the telephone module accesses this. If the hotel is full, the next best hotel is ascertained as the finishing point of the journey.

The user has the option of limiting the destination selection from a destination category to those destinations which are within an area chosen by the user. The area can be selected by placing a type of lasso on a displayed map or by stipulating a finishing point E. In the latter case, the user can choose the destinations either within the district boundaries C for the finishing point E or within a circle or radius r from the finishing point E. In the example shown, the user has used the latter option.

Once the processor had indicated the finishing point E to the user, the user additionally selected the destination category “attractions” as intermediate destinations. This category contains special destinations which are exclusively of tourist interest, and associated information. In this case, he limited the destination selection from the destination category to the radius r around the finishing point E. There, the processor found the attractions or destinations P₁-P₄ and incorporated them into an appropriate journey route. Without limitation of the destination selection, the processor would have provided all the attractions which are on the calculated route and which are within a distance which the user can stipulate from the ideal journey route.

The processor calculated a route R₁ from the starting point S to the finishing point E of the journey, said route first leading to the special destination which is of tourist interest P₁, then to P₂, then to P₃, then to P₄, and finally to the finishing point E.

However, the processor changes the route at the location V₁ of the car on account of a traffic announcement received. The vehicle has to reach the changed location V₂ using the calculated diversion. A check by the processor reveals that, from that point, the special destination P₄ is closer than the originally chosen special destination P₁ in the same destination category. The processor therefore changes the destination and heads for the destination P₄. In addition, a new route is calculated from the destination P₄ to the finishing point E of the journey, which runs via the destinations or intermediate destinations P₁, P₂ and P₃.

The navigation appliance has thus changed a journey destination without user intervention and has automatically compiled a new tourist route or journey guide or town guide.

The processor works in the same way when a change of route is based on the user's whim. In this case, a new destination is ascertained whenever the user has not followed a plurality of guidance instructions to a destination selected by the processor. Such behavior is regarded as an indication that the user does not wish to head for the automatically selected destination.

1. A navigation method with dynamic destination selection, having the following steps:
a processor (11) selects at least one destination (P₁; P₂; P₃; P₄) from a stipulated destination category containing a plurality of destinations (P₁; P₂; P₃; P₄)
a route (R₁) is calculated from a starting point (S) to the destination (P₁; P₂; P₃; P₄) chosen by the processor.

2. The navigation method as claimed in claim 1, characterized in that
a user's respective locations (V₁; V₂) are monitored,
in the event of a change in the location (V₁; V₂), the processor (11) checks whether a new destination (P₁; P₂; P₃; P₄) from the stipulated destination category is closer to the changed location (V₂),
if the new destination is closer to the changed location (V₂), a new route (R₂) is calculated from the changed location (V₂) to the new destination and is output to a user.

3. The navigation method as claimed in the preceding claim, characterized in that the check to determine whether a new destination (P₁; P₂; P₃; P₄) is closer to the changed location (V₂) is carried out if the changed location (V₂) is not on the calculated route (R₁).

4. The navigation method as claimed in claim 2 or 3, characterized in that the processor (11) selects a new destination (P₁; P₂; P₃; P₄) from the stipulated destination category if the user has not followed a plurality of successive guidance instructions to a selected destination (P₁; P₂; P₃; P₄).

5. The navigation method as claimed in one of the preceding claims, characterized in that a destination category contains special destinations which are exclusively of tourist interest, and in that, when this destination category is chosen, the processor selects a succession of the special destinations which are of tourist interest and calculates a route (R₁; R₂) taking into account the selected special destinations.

6. The navigation method as claimed in the preceding claim, characterized in that only special destinations situated within an area chosen by the user are taken into account.

7. The navigation method as claimed in one of the preceding claims, characterized in that at least one destination category contains a plurality of destinations (P₁; P₂; P₃; P₄) which have been selected and stored by the user.

8. The navigation method as claimed in one of the preceding claims, characterized in that at least one of the following criteria is taken into account for selecting the destination (P₁; P₂; P₃; P₄)
opening times of the destination,
departure times of a public transport means,
the level of the charges to be paid for heading for a destination.

9. The navigation method as claimed in one of the preceding claims, characterized in that the destination (P₁; P₂; P₃; P₄) selected by the processor (11) is output to the user, and in that in response to a user input the processor replaces the selected destination (P₁; P₂; P₃; P₄) with a new destination (P₁; P₂; P₃; P₄) from the same destination category.

10. The navigation method as claimed in one of the preceding claims, characterized in that the destination (P₁; P₂; P₃; P₄) selected by the processor (11) is an intermediate destination on a route to a finishing point (E).

11. A navigation appliance having a processor, a user interface, a memory storing a multiplicity of predefined destinations associated with a respective destination category, characterized in that the processor (11) selects at least one of the predefined destinations (P₁; P₂; P₃; P₄) from a selected destination category and calculates a route (R₁; R₂) to this destination (P₁; P₂; P₃; P₄).
